(19) United States
(12) Patent Application Publication
(10) Pub. No.: US 2010/0315945 A1
(43) Pub. Date: Dec. 16, 2010

(54) METHOD, APPARATUS, AND COMPUTER PROGRAM PRODUCT FOR PROVIDING DEVICE MONITORING IN A NETWORK

(75) Inventors: Marcin Wieslaw Matuszewski, Warszawa (PL); Miguel A. Garcia-Martin, Madrid (ES); Christian Schmidt, Augsburg (DE)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/864,655

(22) PCT Filed: Jan. 23, 2009
(86) PCT No.: PCT/IB09/50284

§ 371 Date: Jul. 26, 2010

Related U.S. Application Data
(60) Provisional application No. 61/023,705, filed on Jan. 25, 2008.

(51) Int. Cl. H04L 12/26; G06F 11/00

(52) U.S. Cl. 370/221; 370/252; 370/242

(57) ABSTRACT

A network side apparatus for providing device monitoring in a network includes a processor configured to establish communication between a client device and a network, receive instructions to monitor an availability of at least one other node of the network from the client device, and provide, from a communication device, reports indicating the availability of the at least one other node to the client device. A corresponding method is also provided. A client side apparatus and method are also provided.

### TECHNOLOGICAL FIELD

Embodiments of the present invention relate generally to network communication technology and, more particularly, relate to a method, apparatus and computer program product for providing device monitoring in a network such as, for example, a peer-to-peer (P2P) network.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to provision of information sharing in P2P networks. A P2P network is generally considered a network that relies primarily on the computing power and bandwidth of the devices (i.e., peers) within the network. Accordingly, P2P networks generally do not concentrate computing power and bandwidth within servers. Rather each of the peer devices is capable of simultaneously functioning as both a client and a server to other nodes of the P2P network. The architecture of P2P networks typically involves connecting nodes via largely ad hoc connections over which participant nodes can, for example, share content files containing audio, video, data or virtually anything in a digital format. Accordingly, data such as real time data or address information for use in setting up real time communication could be shared using a P2P network.

Given the ubiquitous nature of mobile terminals, such as mobile phones and numerous other mobile electronic devices, P2P networks are becoming more common for sharing content between individuals in social groups or social networks. These social networks may center on a group of friends, relatives, co-workers, business associates, or people who share a common interest. Each individual (i.e., node) within a social network may be a peer within the P2P network and may invite other individuals to join. As such, although any particular node may generally communicate with a given group of other nodes within the social network, each of the other nodes may subsequently communicate with yet other nodes. Accordingly, within a social network, each node may be defined in terms of a degree of separation from each other node.

P2P networks can provide a mechanism for storing different types of data in a distributed way. In this regard, a distributed hash table (DHT) may define a structured overlay network architecture. A DHT architecture may be enabled to locate a particular piece of data stored in the overlay network using a limited number of messages, typically log(N) messages (N being a number of nodes in the network). Nodes of the overlay network are called peers, and each peer may have a unique peer ID (or node ID), which may be assigned when the peer joins the DHT. Peer IDs are typically created by hashing the Internet Protocol (IP) address of the peer. Thus, if the IP address of the peer changes, the peer ID also changes. The DHT may be organized in a ring topology. Accordingly, peers may exchange DHT-maintenance information with other peers. Typically, peers exchange more information with their neighbor peers than with other more remote peers. In fact, in some instances, neighbors replicate data from other neighbors in order to cope with situations in which one of the peers fails or disconnects from the DHT.

In some situations, a particular device or node may not be enabled to fully participate in the DHT. For example, the particular device may have limited processing power, memory, battery life, or experience connectivity restraints that prevent the device from joining the network overlay layer as a peer. In such situations, the particular device may be able to join the network overlay as a client by connecting to one or more of the peers of the DHT to get DHT services via the connected peer or peers. However, the peers are not necessarily static nodes such as servers maintained by a service operator. Accordingly, the peers may move to another access network or leave the network overlay. When the peer's IP address changes (e.g., due to a new IP address being assigned or if the peer changes the access network), connections to other network nodes (e.g., clients and/or peers) are typically dropped.

In order to provide better redundancy and resilience, clients typically connect to two or more peers simultaneously. The clients typically also continually monitor the connections with the peers (e.g., the connected peers) by exchanging messages (e.g., keep-alive messages). In some cases, a timer may manage the frequency of exchanging such messages (e.g., a 30 second timer). Accordingly, for increased reliability, a client may desire to connect to additional peers. However, each additional connection requires corresponding additional keep-alive messages to be communicated over air interface resources, thereby consuming such resources. Moreover, such messages are typically considered to be maintenance messages that are free of airtime charges.

Accordingly, it may be desirable to provide a mechanism for improving network reliability such as in a P2P network, for example, without incurring a substantial corresponding increase in resource consumption for the network.

### BRIEF SUMMARY

A method, apparatus and computer program product are therefore provided for providing device monitoring in a network. In this regard, one exemplary embodiment will be provided in relation to peer monitoring in a P2P network. However, it should be understood that device monitoring as provided in embodiments of the present invention may also be practiced in connection with other networks in which reliability, redundancy and/or resiliency may be provided by enabling monitoring of other devices at a single point in communication with a client device, rather than requiring the client device to individually monitor every other device.

In an exemplary embodiment, a client device in communication with more than one other device such as a group of peers (e.g., a plurality of connected peer devices or potentially connected peer devices) may designate one of the peers to be a primary connected peer in order to serve as the point of contact for the client with regard to the availability of the other peer devices. In this regard, the primary connected peer may be directed to monitor the availability of the other peers so that the client need only communicate with the primary connected peer in order to determine the status of all or some of the other peer devices. Thus, for example, a client device may be enabled to monitor multiple peers in a group with which the client device may be in communication (or capable of communication) by communicating with one peer to discover the status of the other peers of the group. As such, for example, P2PSIP (P2P session initiation protocol) and other private content sharing platforms may utilize embodiments of the present invention to reduce network communication bandwidth that is consumed for status messages.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a block diagram of an apparatus embodied in a client device for providing device monitoring in a network (e.g., a P2P network) according to an exemplary embodiment of the present invention;

FIG. 3 is a block diagram of an apparatus embodied in a network node for providing device monitoring in a network (e.g., a P2P network) according to an exemplary embodiment of the present invention;

FIG. 4 illustrates an example of a topology of a P2P network utilizing DHT according to an exemplary embodiment of the present invention;

FIG. 5 is a flowchart according to an exemplary method of providing device monitoring in a P2P network according to one embodiment of the present invention;

FIG. 6 is a flowchart according to an exemplary method of providing device monitoring in a network according to one embodiment of the present invention; and

FIG. 7 is a flowchart according to another exemplary method of providing device monitoring in a network according to one embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

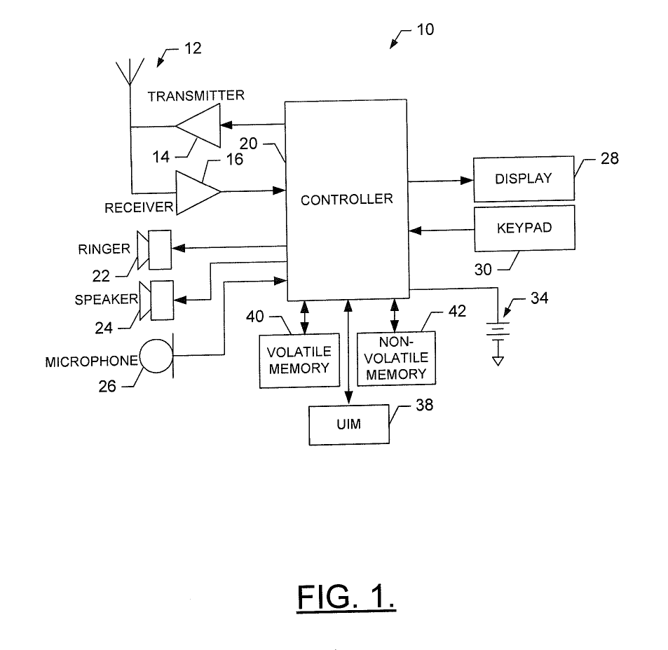

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. In particular, not all apparatuses that employ embodiments of the present invention may comprise all the features illustrated. While several embodiments of the mobile terminal 10 may be illustrated and hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

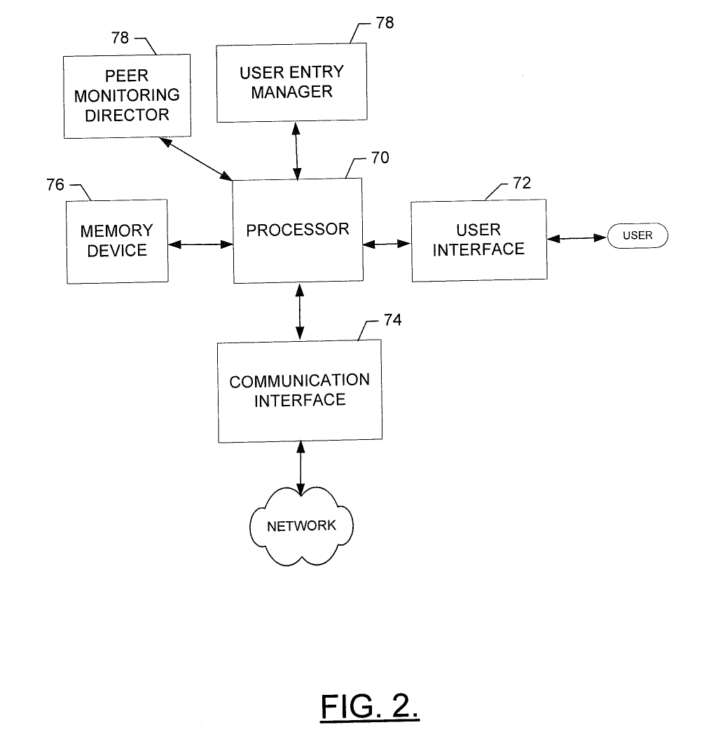

The mobile terminal 10 includes an antenna 12 (or multiple antennae) in operable communication with a transmitter 14 and a receiver 16. The mobile terminal 10 may further include an apparatus, such as a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

In an exemplary embodiment, content or data may be communicated over a particular network between a mobile terminal, which may be similar to the mobile terminal 10 of FIG. 1, and a network device in order to, for example, execute applications or establish communication (for example, for purposes of content sharing or distributed content storage) between the mobile terminal 10 and other mobile terminals or devices (e.g., nodes). As such, it should be understood that embodiments of the present invention may be resident on a communication device such as the mobile terminal 10, and/or may be resident on a camera, server, personal computer or other like devices.

As described above, social networks may be formed via ad hoc connections between various nodes, which could be, for example, mobile terminals, personal or laptop computers, servers, or the like. Such connections may then be utilized to, for example, share access to content which could include video clips, text, audio data, photographs, etc. It should also be understood that accessing content could refer to accessing resources of a particular device. A common way to control access to content has been to provide access control lists (ACLs), which inform a particular device which permissions or access rights each user or group has to specific objects such as files or directories. The access control may be based on the identity of a corresponding user (e.g., username, user ID, etc) or the identity of a device (e.g., device name, media access control (MAC) address, Internet Protocol (IP) address, etc.). By utilizing relationships in social networks, other ways of controlling access to content may be implemented.

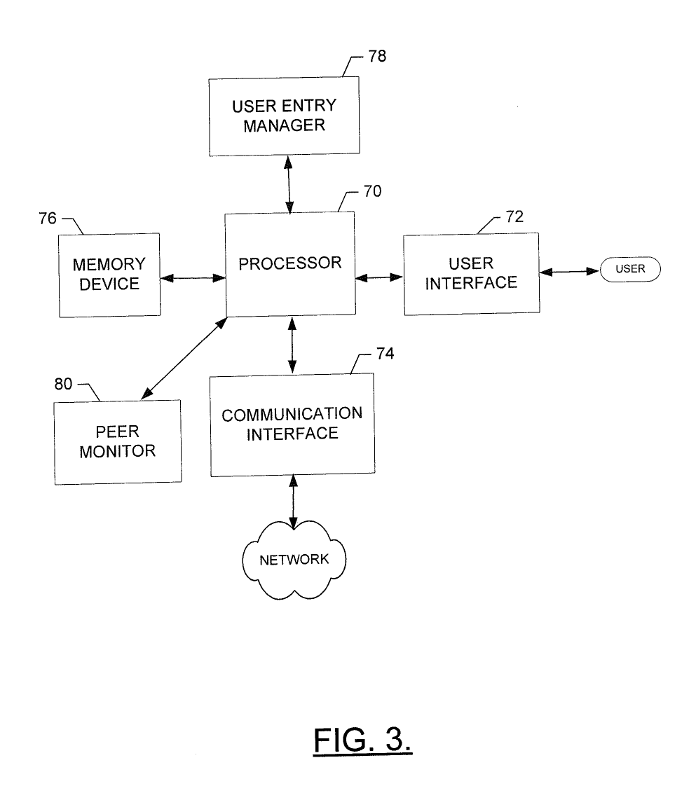

An exemplary embodiment of the invention will now be described with reference to FIGS. 2 and 3, in which certain elements of an apparatus for enabling the provision of peer monitoring in a P2P network are displayed. The apparatus of FIG. 2 may be embodied as or otherwise employed, for example, on a client device such as the mobile terminal of FIG. 1. Meanwhile, the apparatus of FIG. 3 may be embodied on a peer or node device. However, it should be noted that the apparatuses of FIGS. 2 and 3, may also be employed on a variety of other devices, both mobile and fixed, and therefore, embodiments of the present invention should not be limited to application on devices such as mobile terminals. It should also be noted that while FIGS. 2 and 3 illustrate examples of a configuration of an apparatus for enabling the provision of peer monitoring in a P2P network, numerous other configurations may also be used to implement embodiments of the present invention.

Referring now to FIGS. 2 and 3, an apparatus for enabling the provision of peer monitoring in a P2P network is provided. The apparatus may include or otherwise be in communication with a processor 70 (e.g., controller 20), a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as a processing element, a coprocessor, a controller or various other processing means or devices including integrated circuits such as, for example, an ASIC (application specific integrated circuit) or FPGA (field-programmable gate array) or combinations thereof. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may otherwise be a general purpose processing element if not for the specific configuration provided by the instructions, to perform the algorithms and operations described herein. However, in some cases, the processor 70 may be a processor of a specific device (e.g., a mobile terminal) adapted for employing embodiments of the present invention by further configuration of the processor 70 by instructions for performing the algorithms and operations described herein.

Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server, the user interface 72 may be limited, or eliminated. However, in an embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30.

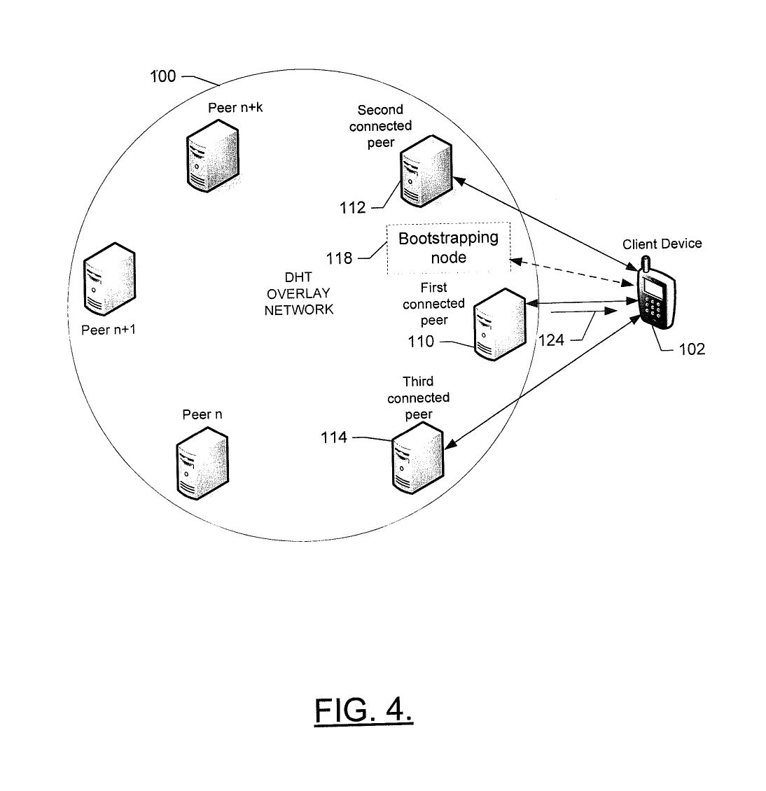

FIG. 4 illustrates an example of a topology of an exemplary network employing device monitoring according to an exemplary embodiment of the present invention. Specifically, FIG. 4 illustrates a diagram in which the exemplary network is a DHT overlay network 100 including various peer devices. However, it should be noted that other networks may also be utilized in connection with embodiments of the present invention. In this regard, for example, the other networks may be P2P networks, overlay networks, or even other networks in which a particular device may connect to another device (e.g., a primary connected device) for a service and, typically for reasons related to a desire for reliability or redundancy for the connection due to the nature of the service, monitor the availability of one or more backup devices to the primary connected device.

As provided in FIG. 4, for example, the DHT overlay network 100 (or simply DHT) may include peer n, peer n+1, peer n+2, . . . , peer n+k. A client device 102 may be in communication with the DHT overlay network 100 via one or more of the peers. In this regard, the client device 102 may establish a connection (e.g., via SIP or another communication protocol) with one or more peer devices, each of which may be considered “connected peers”. For example, as shown in FIG. 4, the client device 102 may be in communication with a first connected peer 110, a second connected peer 112, and a third connected peer 114, each of which may also be included in the DHT overlay network 100. However, it should be noted that although FIG. 4 shows three connected peers, any number of connected peers may be utilized from a single one up to perhaps many.

As indicated above, the client device 102 may, in some instances be unable to get access to the DHT overlay network 100 as a peer device. In this regard, for example, the DHT overlay network 100 may have policy requirements defining particular minimum performance characteristics (e.g., memory available, battery life, availability criteria, processor power, or the like) for obtaining entry into the DHT as a peer device. As such, devices failing to meet the policy requirements may only be granted access to the DHT's services in a client capacity via one of the peers. However, a particular device may also be enabled to access the DHT as a client device for other reasons. For example, the user may desire to access the DHT as a client device and may choose to connect to the DHT as such. Furthermore, in paradigms other than P2P networks, access to particular network devices, nodes or routers that may ultimately be the subject of monitoring in accordance with exemplary embodiments may normally be conducted in a client capacity. In such paradigms, the term “peer” used herein in the examples provided below may typically be replaced with the term “node”.

In an exemplary embodiment, the apparatus of FIG. 2 may be embodied at the client device 102 and/or any or all of the peers. In this regard, when the apparatus is embodied at the client device 102, the processor 70 of the apparatus may be embodied as or otherwise control a peer monitoring director 78. The peer monitoring director 78 may be any means such as a device or circuitry embodied in hardware, software or a combination of hardware and software that is configured to perform the corresponding functions of the peer monitoring director 78 as defined in greater detail below. In this regard, for example, the peer monitoring director 78 may be configured to direct one of the connected devices (or the connected device if there is only one connected device) to act as a primary connected peer. The instruction or direction by the peer monitoring director 78 designating the primary connected peer may cause the primary connected peer to monitor the availability of other peers which may be designated by the client device 102 or by another entity such as a bootstrapping node 118 (shown in dotted lines in FIG. 4 to illustrate the optional nature of the bootstrapping node 118), described in greater detail below. Thus, the peer monitoring director 78 may be configured to communicate with the primary connected peer in relation to providing instructions regarding which other peer devices to monitor and receiving reports regarding the availability of the monitored peer devices. In this regard, the peer monitoring director 78 may, for example, communicate an identity of the peers to be monitored to the primary connected peer and then may receive reports related to the availability of the identified peers. Such communication may be accomplished in numerous ways and via various different message structures. For example, a single message could communicate the status (e.g., availability) of more than one peer device, or multiple messages could communicate the status of corresponding multiple peer devices. For the purposes of example below, the first connected peer 110 may be assumed to act as the primary connected peer.

In an exemplary embodiment in which the apparatus of FIG. 3 is embodied at one or more of the peer devices (e.g., the primary connected or first connected peer 110), the processor 70 of the apparatus may be embodied as or otherwise control a peer monitor 80 (e.g., instead of the peer monitoring director 78). The peer monitor 80 may be any means such as a device or circuitry embodied in hardware, software or a combination of hardware and software that is configured to perform the corresponding functions of the peer monitor 80 as defined in greater detail below. In this regard, for example, the peer monitor 80 may be configured to receive an instruction to monitor other devices from the peer monitoring director 78 (or the bootstrapping node 118). As indicated above, the instruction may include an identity of the devices to be monitored and the peer monitor 80 may thereafter be configured to communicate with the peer monitoring director 78 to provide information relative to the availability or status of devices being monitored (e.g., peers being monitored). For the purposes of example below, the first connected peer 110, the second connected peer 112, and the third connected peer 114 are collectively referred to as “connected peers”. The second connected peer 112 and the third connected peer 114 may be assumed to be secondary peers (or secondary connected peers) identified by the peer monitoring director 78 for monitoring by the primary connected peer (e.g., the first connected peer 110). However, it should be noted that the devices being monitored for availability or status reporting need not necessarily be connected to the client device 102. As such, the report on availability could simply notify the client device 102 of the availability for the client device 102 to shift communication to one of the available other devices (e.g., in case the primary connected device becomes disconnected or otherwise unavailable).

The bootstrapping node 118 may be any means such as a device or circuitry embodied in hardware, software or a combination of hardware and software that is configured to communicate with the client device 102 to assist with regard to facilitating an identification of available peers for connection to the DHT overlay network 100. For example, the bootstrapping node 118 may initially provide the client device 102 with a listing of currently available nodes or peers from which the client device 102 may select one or more to which a connection may be established. Furthermore, the bootstrapping node 118 may enable the client device 102 to designate a particular peer as the primary connected peer and/or designate other peers or nodes to be monitored. The bootstrapping node 118 may be an optional device. Additionally, the bootstrapping node 118 may be collocated with or even be embodied as one of the peer devices. Alternatively, the bootstrapping node 118 may be a single, central device within the network. In an exemplary embodiment, the bootstrapping node 118 may provide information to the client device 102 for use by the client device 102 in selection of proper secondary peers for monitoring.

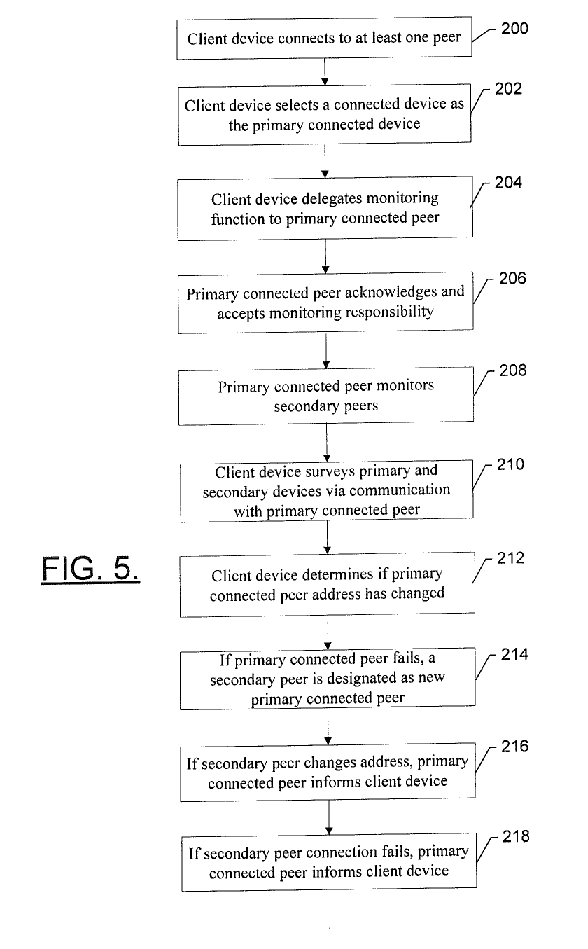

During operation, as shown in the exemplary flowchart of FIG. 5, the client device 102 may initially connect to at least the first connected peer 110 for provisioning DHT connectivity services at operation 200. In this example, the client device may also connect to the second and third connected peers 112 and 114. The client device 102 may then select one of the connected peers (e.g., the first connected peer 110) as a main point of contact to the DHT overlay network 100 at operation 202 to thereby designate the selected connected peer as the primary connected peer. Other connected peers may therefore be considered to be secondary connected peers. At operation 204, the client device 102 may delegate monitoring functions regarding the availability of the secondary connected peers to the primary connected peer. In an exemplary embodiment, operation 204 may include instructions (or a request) to the primary connected peer with regard to any or all of the following: which devices to monitor, monitoring frequency, reporting frequency, reporting format, or the like. The primary connected peer may acknowledge the instructions (or request) and accept responsibility for monitoring the secondary connected peers at operation 206. The primary connected peer may generate periodic communications (e.g., keep-alive messages) with each of the secondary connected peers at operation 208 to determine the availability of each of the secondary connected devices with regard to the ability of each secondary connected device to serve as a connection source for the client device 102 to access the DHT overlay network 100. At operation 210, the primary connected device may communicate with the client device 102 (e.g., with keep-alive messages) regarding the status of all of the connected devices. In other words, the primary connected device communicates with the client device 102 to provide all information regarding the availability of each of the devices to be monitored from a single source. As such, the client device 102 need not communicate with every device, but instead may only communicate with the primary connected device in order to ascertain the availability of other devices that may provide redundancy or reliability related assurances to the client device 102. Thus, the client device 102 may be enabled to monitor the availability of multiple devices while conducting communications with only a single device to which the responsibility of monitoring the other devices has been delegated.

If a particular device being monitored (e.g., a secondary connected peer) becomes unavailable, the client device 102 may be made aware of the unavailability of the corresponding device by receipt of a message indicating the unavailability of the device from the primary connected peer. Alternatively, the client device 102 may not receive an indication of the availability of the corresponding device from the primary connected peer within a defined reporting period, thereby implicitly indicating the unavailability of the device. In an exemplary embodiment, upon becoming aware of the loss of availability of a particular monitored device (e.g., a secondary connected peer such as the second connected peer 112) the client device 102 may replace the now unavailable device with another device that is available. In this regard, for example, the client device 102 may communicate with the bootstrapping node 118 or otherwise inquire as to which other devices are available. The client device 102 may then select one or more of the available devices to be monitored and/or to be the subject of a connection to replace the now unavailable device.

In an exemplary embodiment, if the primary connected peer changes its IP address for some reason (e.g., due to handover), the client device 102 may become aware of the change at operation 212. In this regard, the client device 102 may receive notice from the primary connected peer of an impending change, or may determine that such change has occurred after the fact. In some instances (e.g., if the client device 102 is behind a network address translation (NAT) gateway), the primary connected peer may not be able to notify the client device 102 of an impending change of IP address. Accordingly, the client device 102 may detect the loss of its primary connection (e.g., by failure to receive keep-alive messages from the primary connected device) and may select a new primary connected peer. However, as an alternative, some embodiments may enable the primary connected peer to utilize the old connection to the client device 102 to inform the client device 102 of the impending change. The client device 102 may therefore designate one of the secondary connected peers as a new primary connected peer to continue communication without interruption. As yet another example, a combination of the above situations may be employed. As such, for example, if the primary connected peer has knowledge of an impending handover, the primary connected peer may inform the client device 102, however, if the client device 102 is not informed, the client device 102 may still determine the change by a loss of receipt of keep-alive messages from the primary connected device.

Determination of a lost connection and selection of a new primary connected peer is illustrated at operation 214. If one of the former secondary connected peers becomes the new primary connected peer, a replacement secondary connected peer may be determined as provided above. The new primary connected peer may receive instructions from the client device 102 (e.g., via the peer monitoring director 78) regarding peer monitoring and reporting to the client device 102 subsequent to or along with receipt of instructions to take on primary connected peer responsibilities.

If a secondary connected peer changes its IP address, (e.g., due to a handover), the secondary connected peer may inform the DHT and the primary connected peer of the change. The primary connected peer may then inform the client device 102 (and in some instances also the other peers) of the change at operation 216. Similarly, if a secondary connected peer fails to respond within a predefined period to an inquiry (e.g., a keep-alive message) from the primary connected peer, the primary connected peer may notify the client device of the failure via an availability report message 124 at operation 218. The client device 102 may then select another secondary connected peer (or other non-connected device) to connect to and/or monitor.

The exemplary embodiment of FIG. 5 may reduce the number of exchanged keep-alive messages that are communicated over an air interface between the client device 102 (which may typically be a mobile terminal), by instead relegating such messages to communication between peers (which may not be communicating over an air interface). However, embodiments of the present invention still enable the provision of redundancy, reliability and resiliency. In this regard, the client device 102 is enabled to directly monitor only a single peer device or a plurality of peer devices, while indirectly monitoring a plurality of secondary or potential backup devices. The indirectly monitored devices may be devices to which the client device 102 is also connected, or to which the client device 102 may wish to connect in the event of a loss of the primary device. As such, if the primary device becomes unavailable (e.g., due to failure), the client device 102 may detect the loss (e.g., due to keep-alive timers expiring) and may react accordingly. The client device 102 may also detect or be informed of IP address changes of connected peers and may react accordingly, as described above.

FIGS. 5-7 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

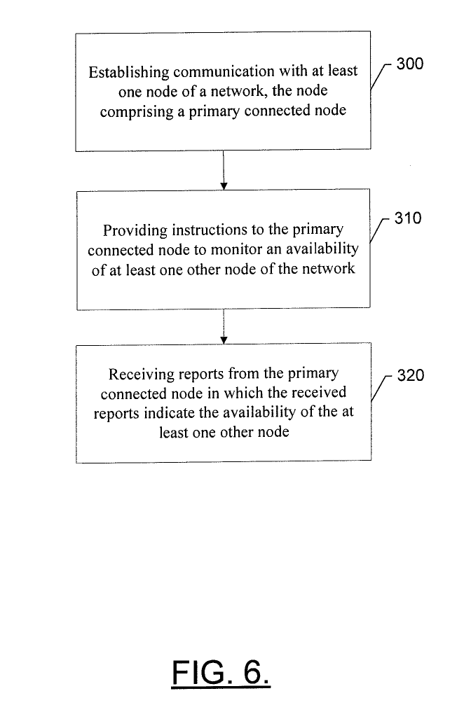

In this regard, one embodiment of a method of providing device monitoring in a network, as shown in FIG. 6, may include establishing communication with at least one node of a network at operation 300. The at least one node may be referred to as a primary connected node after the establishment of communication. As indicated above, the network could be a P2P network such as a DHT overlay network. The method may further include providing instructions to the primary connected node. The instructions may direct the primary connected node to monitor an availability of at least one other node of the network at operation 310. At operation 320, reports may be received from the primary connected node in which the received reports indicate the availability of the at least one other node. The availability indications may be with respect to an ability of a device such as a client device executing the method to connect to the network via the respective node to which the availability indication corresponds.

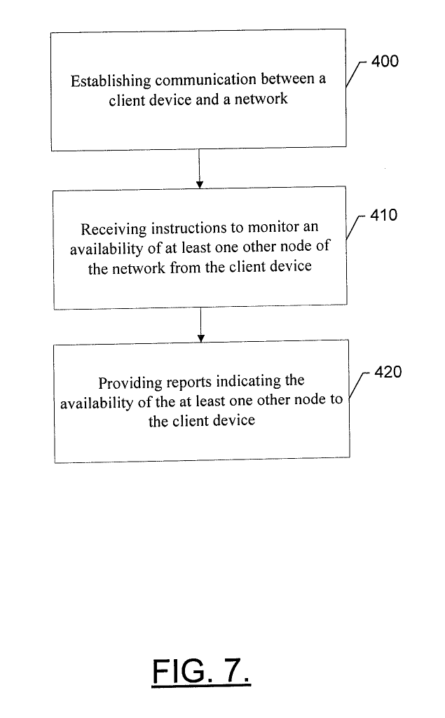

In another embodiment, a method of providing device monitoring in a network from a network node (e.g., primary connected peer) perspective, as shown in FIG. 7, is provided. The method may include establishing communication between a client device and a network at operation 400. As indicated above, the network could be a P2P network such as a DHT overlay network. The method may further include receiving instructions from the client device. The instructions may direct the monitoring of an availability of at least one other node of the network at operation 410. At operation 420, reports may be sent to the client device in which the reports indicate the availability of the at least one other node. The availability indications may be with respect to an ability of a device such as the client device to connect to the network via the respective node to which the availability indication corresponds.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1.-33. (canceled)

34. A method comprising:
establishing communication with at least one node of a network, the node comprising a primary connected node;
providing, from a communication device, instructions to the primary connected node to monitor an availability of at least one other node of the network;
receiving at least one report from the primary connected node, wherein the received at least one report indicates the availability of the at least one other node; and
wherein the received at least one report comprises availability indications with respect to an ability of the communication device to connect to the network via the at least one other node to which the availability indication corresponds.

35. The method of claim 34, wherein providing instructions to the primary connected node comprises designating the primary connected node to serve as a point of contact for the communication device with regard to the status of the said at least one other node.

36. The method of claim 34, wherein receiving at least one report from the primary connected node comprises receiving a message at a predetermined interval to enable a determination of a loss of a corresponding node in response to a failure to receive the message.

37. The method of claim 34, wherein receiving at least one report from the primary connected node comprises receiving an indication from the primary connected node of an address change of a node.

38. The method of claim 34, further comprising designating a new primary connected node in response to failure of the primary connected node.

39. An apparatus, comprising:
at least one processor; and
at least one memory including computer program code
the at least one memory and computer program code configured to, with the at least one processor, cause the apparatus to perform at least the following:
establish communication with at least one node of a network, the node comprising a primary connected node;
provide, from the apparatus, instructions to the primary connected node to monitor an availability of at least one other node of the network;
receive at least one report from the primary connected node wherein the received at least one report indicates the availability of the at least one other node; and
wherein the received at least one report comprises availability indications with respect to an ability of the communication device to connect to the network via the at least one other node to which the availability indication corresponds.

40. The apparatus of claim 39, wherein the instructions comprise designating the primary connected node to serve as a point of contact for the communication device with regard to the status of the at least one other node.

41. The apparatus of claim 39, wherein the receiving the at least one report comprises receiving a message at a predetermined interval to enable a determination of a loss of a corresponding node in response to a failure to receive the message.

42. The apparatus of claim 39, wherein the receiving the at least one report comprises receiving an indication from the primary connected node of an address change of a node.

43. The apparatus of claim 39, wherein the processor is further configured to designate a new primary connected node in response to failure of the primary connected node.

44. A computer program product comprising at least one computer-readable storage medium having computer-executable program code instructions stored therein, the computer-executable program code instructions comprising:
program code instructions for establishing communication with at least one node of a network, the node comprising a primary connected node;
program code instructions for providing, from a communication device, instructions to the primary connected node to monitor an availability of at least one other node of the network; and
program code instructions for receiving at least one report from the primary connected node, wherein the received at least one report indicates the availability of the at least one other node; and
wherein program code instructions for receiving at least one report comprise instructions for receiving availability indications with respect to an ability of the communication device to connect to the network via the at least one other node to which the availability indication corresponds.

45. A method comprising:
establishing communication between a communication device and a network;
receiving instructions to monitor an availability of at least one node of the network from the communication device;
providing, to the communication device, at least one report indicating the availability of the at least one node to the communication device; and
wherein the at least one report comprises availability indications with respect to an ability of the communication device to connect to the network via the at least one node to which the reports indicating availability correspond.

46. The method of claim 45, wherein receiving instructions to monitor comprises receiving a designation to serve as a point of contact for the communication device with regard to the status of the at least one node.

47. The method of claim 45, wherein providing the at least one report comprises providing a message at a predetermined interval to enable a determination of a loss of a corresponding node in response to a failure to provide the message.

48. The method of claim 45, wherein providing at least one report comprises providing an indication to the communication device of an address change of a node.

49. An apparatus, comprising:
at least one processor; and
at least one memory including computer program code
the at least one memory and computer program code configured to, with the at least one processor, cause the apparatus to perform at least the following:
establish communication between a communication device and a network;
receive instructions to monitor an availability of at least one node of the network from the communication device;
provide, from the apparatus, at least one report indicating the availability of the at least one node to the communication device; and
wherein the at least one report comprises availability indications with respect to an ability of the communication device to connect to the network via the at least one node to which the reports indicating availability correspond.

50. The apparatus of claim 49, wherein the instructions comprise a designation to serve as a point of contact for the communication device with regard to the status of the at least one node.

51. The apparatus of claim 49, wherein the providing the at least one report comprises providing a message at a predetermined interval to enable a determination of a loss of a corresponding node in response to a failure to provide the message.

52. The apparatus of claim 49, wherein the providing the at least one report comprises providing an indication to the communication device of an address change of a node.

53. A computer program product comprising at least one computer-readable storage medium having computer-executable program code instructions stored therein, the computer-executable program code instructions comprising:
program code instructions for establishing communication between a communication device and a network;
program code instructions for receiving instructions to monitor an availability of at least one node of the network from the communication device;
program code instructions for providing, from the communication device, at least one report indicating the availability of the at least one node to the communication device; and
wherein program code instructions for providing at least one report include instructions for providing availability indications with respect to an ability of the communication device to connect to the network via the at least one node to which the reports indicating availability correspond.
